(19) United States
(12) Patent Application Publication
(10) Pub. No.: US 2009/0151434 A1
(43) Pub. Date: Jun. 18, 2009

(54) Apparatus and method using a disk drive slider and/or a peltier plate in an atomic force microscope

(75) Inventors: Dongman Kim, Campbell, CA (US); Michael Sullivan, Fremont, CA (US); Keung Youn Cho, San Jose, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD

(21) Appl. No.: 12/002,631

(22) Filed: Dec. 17, 2007

(51) Int. Cl. G01B 5/28

(52) U.S. Cl. 73/105

(57) ABSTRACT

An Atomic Force Microscope (AFM) using a cantilevered probe containing a slider of a kind useable in a disk drive. The AFM may use a test surface similar to a disk surface in the disk drive and measure friction, lubricant depletion, and/or scratch test in the AFM to estimate the same under conditions experienced in the disk drive. The AFM may also include a Peltier plate thermally coupled to test object to maintain test surface at controlled test temperature. Refinements of the measurements are disclosed.

### TECHNICAL FIELD

This invention relates to using a slider as a probe in an atomic force microscope and/or the use of a Peltier plate to control the temperature of a test surface in an atomic force microscope.

### BACKGROUND OF THE INVENTION

Atomic force microscopes have been in use for several years in analyzing some material properties of disks used in hard disk drives, such as friction/adhesion force on disk surfaces. Typically, these microscopes use a cantilever positioning a probe often made of Si₃N₄ with a silicon doped tip coated with aluminum or gold when measuring the surface energy. While these measurements were an improvement over the past, they do not adequately reveal what would happen if the same surface is used with a slider in a disk drive, because probes and sliders are made of fundamentally different materials and do not interact the same with the surface.

Another problem with atomic force microscopes is that they require an expensive temperature control stage to control the temperature of surfaces being tested. A new, less expensive temperature control mechanism would be very useful.

### SUMMARY OF THE INVENTION

One embodiment of the invention includes an Atomic Force Microscope (AFM) with a test stand for a test object including a test surface and a positioning mechanism for a cantilevered probe including a cantilever coupled to a slider used in a disk drive. The disk drive may be a ferromagnetic and/or a ferroelectric disk drive.

The test surface may be composed as a disk surface in the disk drive. The slider positioned over the test surface creates a friction-adhesion measurement to estimate the friction-adhesion of the slider over a disk surface, and/or a lubricant depletion measurement to estimate the lubricant depletion, and/or a scratch test measurement to estimate a scratch test of the slider on the disk surface in the disk drive.

The cantilevered probe preferably includes a cantilever coupled to a slider useable in a disk drive, where the cantilever is configured for AFM use.

The AFM may include a Peltier plate configured to thermally couple to a test object to create the test surface at a controlled test temperature and may be used to refine the above-mentioned estimates to account for the controlled test temperature in the disk surface. The Peltier plate may be used with cantilevered probes that do not include a slider.

### BRIEF DESCRIPTION OF THE DRAWINGS

FIG. 1 shows an example of an embodiment of the Atomic Force Microscope (AFM) including a positioning mechanism and/or a Peltier plate for coupling to a test object including a test surface. The positioning mechanism is configured to couple through an embodiment of a cantilevered probe to a slider of a kind used in a disk drive. The disk drive is shown as a ferromagnetic disk drive in FIG. 2 and as a ferroelectric disk drive in FIG. 6. The cantilevered probe embodiment includes a cantilever coupled to the slider. A control circuit may operate the AFM to create at least one friction measurement and/or lubricant depletion measurement and/or scratch test measurement to estimate the conditions inside the disk drive as shown in FIGS. 2 and 6. The Peltier plate may be used to maintain the test surface at a controlled test temperature.

FIG. 2 shows an example of a disk drive including and using the slider of FIG. 1 over an example of a disk surface similar to the test surface. The slider may include a vertical micro-actuator or heating element near reader/writer that is used in the disk drive to alter and control the flying height of the read-write head based upon the condition of the air bearing formed by airflow off the rotating disk surface between the air bearing surface and the disk surface.

FIG. 3 shows some details of the AFM of FIG. 1 including an atmospheric chamber containing at least the slider and test surface to control at least one of an air temperature, test humidity. The measurements of the friction, the lubricant depletion and/or the scratch test may be refined by changes to the condition of the air. Using a slider for a ferroelectric disk drive, the AFM may be used to create a contact pressure measurement to estimate the contact pressure within the ferroelectric disk drive when the spring constant of the probe can be estimated.

FIGS. 4 and 5 show flowcharts of the program system instructing the computer as follows: FIG. 4 shows steps for the computer to operate the AFM with the cantilevered probe positioning the slider over the test surface to create at least one of a friction measurement, a lubrication depletion measurement, and/or a scratch test measurement. FIG. 5 shows steps for operating the Peltier plate to maintain the test surface at the controlled test temperature and/or refining at least one of the measurements to account the controlled test temperature.

FIG. 6 shows an example embodiment of the slider and disk surface of a ferroelectric disk drive. The slider may include a resistive probe. The slider is preferably coupled to a vertical micro-actuator or integrated with heating elements near reader/writer to control the contact and the contact pressure of the probe on the disk surface.

FIG. 7 shows some further details of embodiments of the test and disk surfaces, and the resistive probe of the slider of a kind used to form and access a ferroelectric cell at a probe site on the disk surface.

### DETAILED DESCRIPTION

This invention relates to using a slider, such as those generally found in or otherwise useable in a disk drive, in an atomic force microscope, instead of a probe typically used in an atomic force microscope. The invention also relates to the use of a Peltier plate to control the temperature of a test surface in an atomic force microscope.

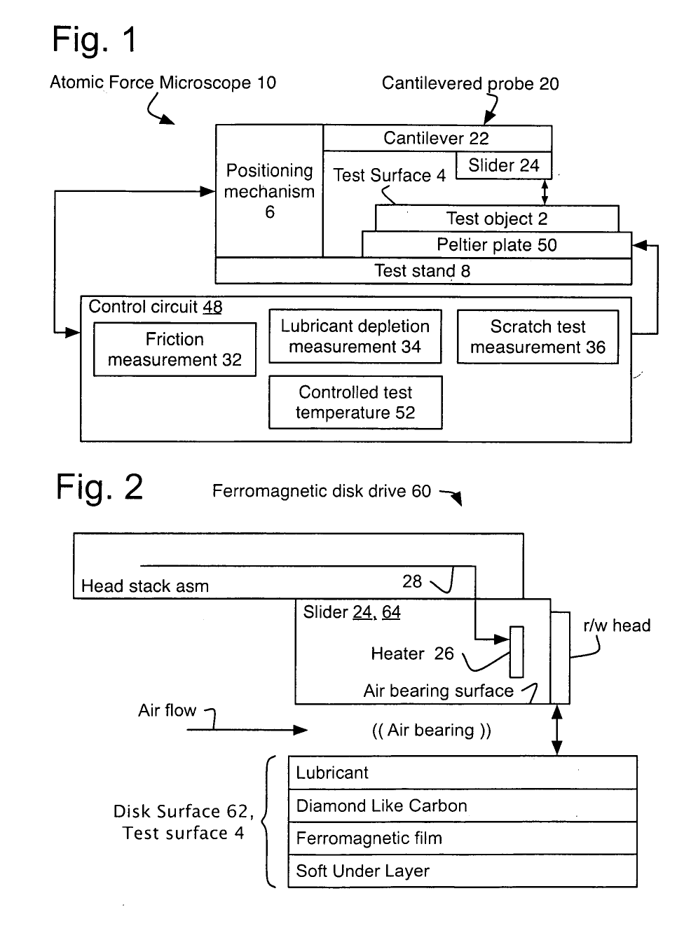

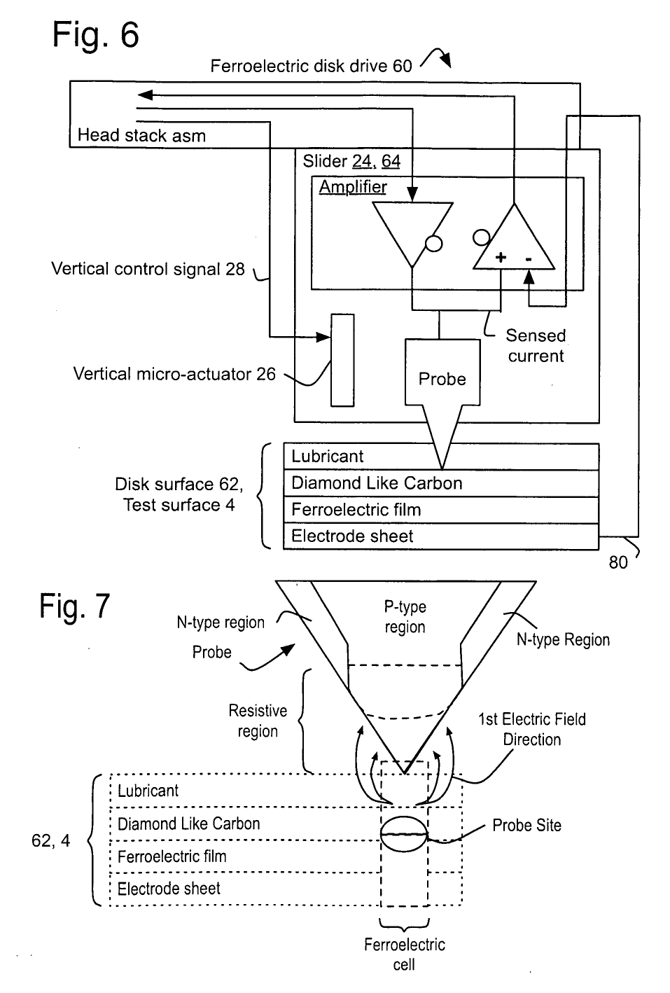

Referring to the drawings more particularly by reference numbers, FIG. 1 shows an example embodiment of the Atomic Force Microscope (AFM) 10 with a test stand 8 and may include a positioning mechanism 6 mounted on a test stand and/or a Peltier plate 50 mounted on the test stand for coupling to a test object 2 including a test surface 4. The positioning mechanism couples through an embodiment of a cantilevered probe 22 to a slider 24 of a kind used in a disk drive 60, shown through the examples of a ferromagnetic disk drive in FIG. 2 and a ferroelectric disk drive in FIG. 6. While two examples have been provided, embodiments of the invention may incorporate virtually any slider usable in a hard disk drive. The cantilevered probe includes a cantilever 22 coupled to the slider. A control circuit 48 may operate the AFM to create at least one friction measurement 32 and/or lubricant depletion measurement 34 and/or scratch test measurement 36 to estimate similar conditions inside the disk drive. The control circuit may operate the Peltier plate to maintain the test surface at a controlled test temperature 52 whether or not the preferred cantilevered probe is being used.

As used herein, the term Atomic Force Microscope (AFM) 10 will refer to a scanning probe microscope using a positioning mechanism 6 coupled through a cantilever 22 to a probe to measure at least one physical property of a test surface 4 of a test object 2. Often the physical properties are measured by observing the deflection of the cantilever. In some circumstances, the resistance, voltage drop, and/or current between the probe and a second terminal may also be measured.

A control circuit 48 may operate the AFM 10 to use the cantilevered probe 20 with the slider 24 positioned over the test surface 4 composed as a disk surface 62 to create a friction-adhesion measurement 32 to estimate the friction-adhesion of the disk slider 24 over the disk surface 62 in the disk drive 60, to create a lubricant depletion measurement 34 to estimate the lubricant depletion of the disk slider over the disk surface, and/or to create a scratch test measurement 36 to estimate the scratch test of the slider on the disk surface.

The test surface 4 may preferably be composed of material for use as a disk surface 62 in the disk drive 60. The disk drive may be a ferromagnetic disk drive as shown in FIG. 2 and/or it may be a ferroelectric disk drive as shown in FIG. 6. The slider 24 may be similar to the disk slider 24 of a ferromagnetic disk drive and/or it may be similar to the disk slider of a ferroelectric disk drive. The similarity may be complete up to the point of coupling the slider to the cantilever 22, which tends to be a permanent installation. Epoxy may be used couple the cantilever to the slider.

Another embodiment of the invention involves a cantilevered probe 20 including a cantilever 22 coupled to a slider 24 of a kind used in a disk drive 60, and the cantilever is configured for use in an AFM 10. The cantilevered probe may further include a vertical micro-actuator 26 coupled to the slider and at least one vertical control signal 28 provided to the vertical micro-actuator to alter a height 30 of the slider over the test surface 4. The vertical micro-actuator may further be included in the slider. As used herein a vertical micro actuator preferably refers to at least one heating element near read-write head which may include writers and readers.

In certain embodiments, the AFM 10 may include a Peltier plate 50, mounted on the test stand 8, configured to thermally coupled to the test object 2 to bring the test surface 4 to a controlled test temperature 52. The AFM may or may not use the cantilevered probe including a slider when using the Peltier plate.

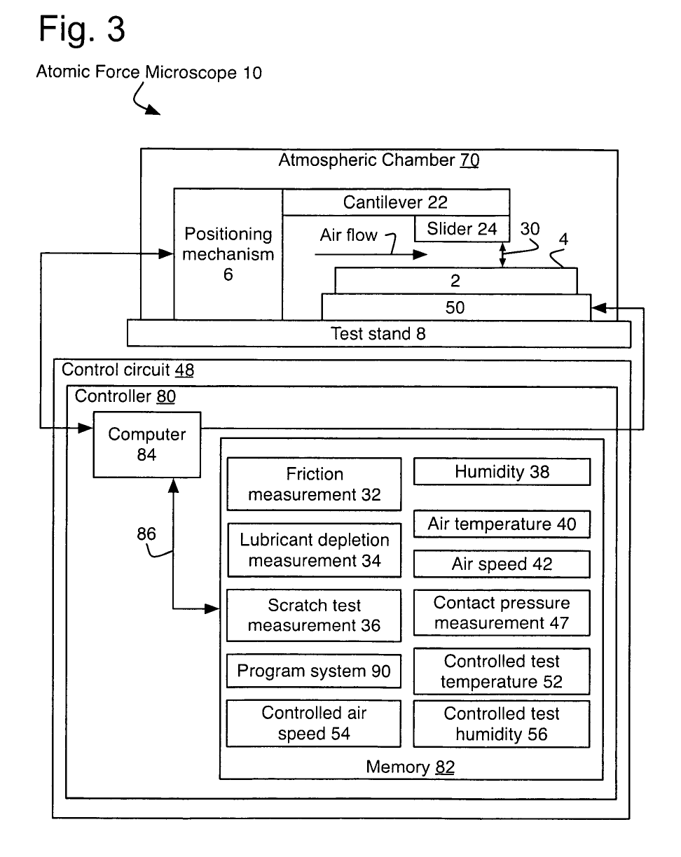

Preferably, the Peltier plate 50 is thermally coupled to the test object 2 and operated to maintain the test surface 4 at the controlled test temperature 52. This supports refining the above-mentioned measurements 32, 34 and 36 to estimate those conditions at controlled test temperatures in the disk drive 60. An atmospheric chamber 70 shown in FIG. 3 may supply a flow of helium or other selected gasses near the cantilevered probe 20 and the test surface 4 to help maintain the test surface at the controlled test temperature.

FIG. 2 shows an example of a disk drive 60 including and using the slider 24 of FIG. 1 over an example of a disk surface 62 similar to the test surface 4. The slider may include a vertical micro-actuator 26 that is used in the disk drive to alter and control the flying height of the read-write head based upon the condition of an air bearing formed by airflow off the rotating disk surface between the air bearing surface and the disk surface.

While in general the slider 24 may be coupled to a vertical micro-actuator 26, in many embodiments, it will be preferred that the slider include a heater as shown in FIG. 2. At least one vertical control signal 28 is stimulated in the disk drive often through the head stack assembly, whereas in certain embodiments of the AFM 10, these signals are provided through the cantilevered probe 20, and possibly the cantilever 22. The slider includes a read/write head that may or may not be used in the AFM, but is used in the disk drive to access data on the disk surface 62.

The air bearing operates with the vertical micro-actuator 26 bringing the read-write head within the flying height off of the disk surface 62. The flying height is now frequently less than 10 nanometers (nm) and recently it has been found that under certain conditions of air temperature 40, humidity 38 and air speed 42, condensation can form dropping the pressure in the air bearing and potentially leading to crashing the slider into the disk surface. These conditions can be estimated with a refinement of the AFM 10 as shown in FIG. 3.

FIG. 3 shows some refinements of the AFM 10 of FIG. 1 including an atmospheric chamber 70 configured to contain at least the slider 24 and the test surface 4 and configured to maintain air at a controlled test humidity 56, a controlled test temperature 52 and/or a controlled air speed 54. These control variables can be used to refine the estimates to account for the air at various combinations of these conditions in the disk drive 60.

Using a slider 24 for a ferroelectric disk drive 60, the AFM 10 may be used to generate a contact pressure measurement 47 to estimate the contact pressure within the ferroelectric disk drive.

The control circuit 48 may preferably include at least one instance of a controller 80 including at least one computer 84 operating the AFM 10 and/or operating the Peltier plate 50 as instructed by a program system 90. The program system includes program steps residing in the memory 82 accessibly coupled via a bus 86 to the computer. Each controller as used herein receives at least one input, updates and maintains at least one state, and generates at least one output based upon the value of at least one of the inputs and/or at least one of the states. A controller may also include a finite state machine and/or a neural network and/or an inferential engine.

The computer 84 may include at least one data processor and at least one instruction processor instructed by the program system to at least partly operate the AFM 10 and/or the Peltier plate 50 as disclosed herein. Each of the data processors may be instructed by at least one of the instruction processors.

Note that the program steps included in the program system 90 may represent the actions of various states of the finite state machine. The memory 82 may include a non-volatile memory component and/or a volatile memory component. As used herein, a non-volatile memory component retains its memory state without required power and a volatile memory component tends to lose its memory state without at least occasionally being supplied power.

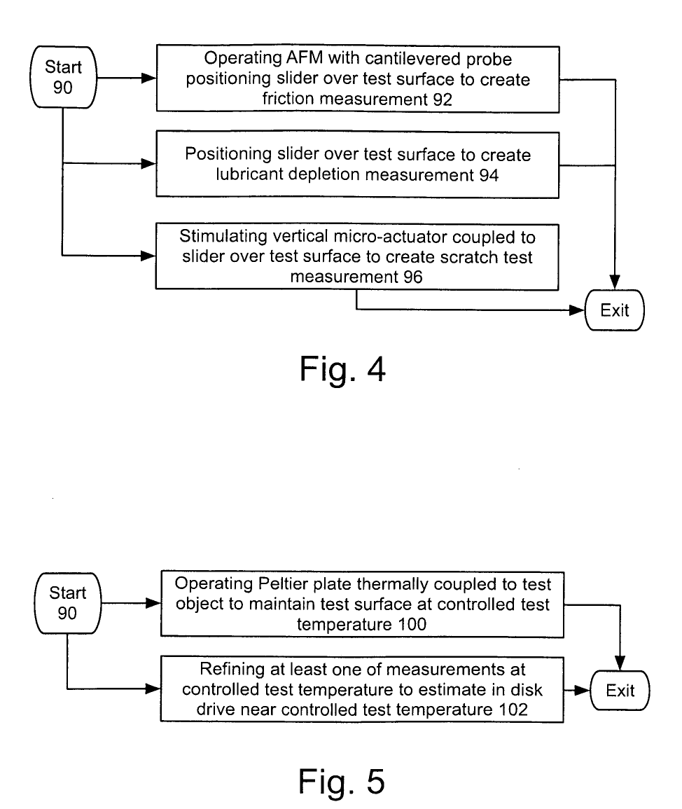

FIGS. 4 and 5 show flowcharts of program steps for operating the AFM 10 embodiment of FIG. 3.

FIG. 4 shows the program system 90 may include at least one of the following: Program step 92 assists in operating the AFM 10 with the cantilevered probe 20 positioning the slider 24 over the test surface 4 to create at least one of a friction measurement 32. Program step 94 again assists in operating the AFM to position the slider over the test surface to create a lubrication depletion measurement 34. Program step 96 assists in operating the AFM to position the slider over the test surface to create a scratch test measurement 36.

FIG. 5 shows the program system 90 may include at least one of the following: Program step 100 assists in operating the Peltier plate 50 to maintain the test surface 4 at the controlled test temperature. Program step 102 assists in refining at least one of the measurements, 32, 34 and/or 36 to account for the controlled test temperature.

FIG. 6 shows a simplified schematic of an example embodiment of the slider 24 and disk surface 62 of the disk drive 60 as a ferroelectric disk drive. The slider may or may not include an amplifier and may or may not include a vertical micro-actuator 26. The slider does include a resistive probe shown in further detail in FIG. 7. The slider is preferably coupled to a vertical micro-actuator to control the contact and the contact pressure of the probe on the disk surface.

The resistive probe in the slider 24 may use the electrode path 80 to create a circuit between the electrode sheet and the resistive probe contacting the disk surface 62 at a probe site to access a ferroelectric cell. The ferroelectric cell may be formed between the resistive probe site on the resistive probe surface, the ferroelectric film between the resistive probe surface and the electrode sheet through the electrode path.

The electrode sheet may be deposited on a disk substrate. The disk substrate may include a glass disk substrate and/or a metallic disk substrate similar to those used in contemporary ferromagnetic disks for hard disk drives. The electrode sheet may include at least one conductive metal. For the purpose of clarity, the application will speak of the electrode sheet and the disk substrate as distinct, however there may be embodiments where they are essentially the same.

The ferroelectric film may include a concentration, essentially consisting of the group of elements in a mixture: lead (Pb), zirconium (Z), titanium (Ti), and oxygen (O). These elements may further form a compound, and the ferroelectric film may preferably include the Pb(Zr_{0.4}Ti_{0.6})O₃ compound. The concentration may preferably be at least ninety percent of the molecular weight of the ferroelectric film.

The disk surface 62 and similarly the test surface 4 may preferably include a layer of Diamond Like Carbon (DLC) topped by a layer of lubricant. The resistive probe preferably contacts the lubricant layer without penetrating it, thereby avoiding solid-to-solid contact with the DLC layer. The DLC layer may be manufactured by high energy deposition of carbon on the ferroelectric film. The lubricant layer may include at least one lubricant compound from the perfluoropolyether family.

FIG. 7 shows some further details of embodiment of the test surface 4 and disk surface 62, the resistive probe of the slider 24 as used to access a ferroelectric cell at a probe site on the disk surface. It shows the operation of the ferroelectric cell with regards to a first electric field direction. The resistive probe may include an N-type region which preferably surrounding a P-type region, both of which couple to a resistive region contacting the disk surface 62, preferably, the lubricant layer. Typically the ferroelectric disk drive 60 also uses a second electric field direction essentially opposite the first electric field direction. A bit is recorded by selecting one of these electric field directions, which is retained in a nonvolatile manner, without the need for a regular supply of electrical power.

Reading the ferroelectric cell in the ferroelectric disk drive 60 uses the electrode path 80 to electrically couple the electrode sheet to the resistive probe to detect a sensed current between the resistive probe and the electrode sheet.

The preceding embodiments provide examples of the invention and are not meant to constrain the scope of the following claims.

What is claimed is:

1. An atomic force microscope, comprising:
a positioning mechanism coupled to a test stand and configured to position a cantilevered probe over a test surface, said cantilevered probe including a cantilever coupled to a slider of a kind useable in a disk drive.

2. The atomic force microscope of claim 1, further comprising:
a Peltier plate mounted on a test stand and configured to thermally couple to a test object, said Peltier plate being configured to maintain said test surface of said test object at a controlled test temperature.

3. The atomic force microscope of claim 1, wherein said test surface is similar to a disk surface of said disk drive.

4. The atomic force microscope of claim 1, wherein said disk drive is a ferromagnetic disk drive.

5. The atomic force microscope of claim 1, wherein said disk drive is a ferroelectric disk drive.

6. The atomic force microscope of claim 1, further comprising an atmospheric chamber configured to contain said cantilevered probe and said test surface to supply at least one of:
a flow of gas near said cantilevered probe and near said test surface, and
a flow of gas between said slider and said test surface at a controlled relative humidity and a controlled air temperature.

7. The atomic force microscope of claim 6, wherein said cantilevered probe further includes a vertical micro-actuator coupled to said slider.

8. The atomic force microscope of claim 7, wherein said slider includes said vertical micro-actuator.

9. An atomic force microscope, comprising:
a Peltier plate mounted on a test stand and configured to thermally couple to a test object, said Peltier plate being configured to maintain said test surface of said test object at a controlled test temperature.

10. A method, comprising the step of:
operating an atomic force microscope with a cantilevered probe containing a slider of a kind useable in a disk drive, said slider positioned over a test surface to create a measurement of a friction-adhesion to estimate said friction-adhesion of said slider over a disk surface in said disk drive, whereby said test surface is similar to said disk surface.

11. The method of claim 10, further comprising the step of:
operating said atomic force microscope with said cantilevered probe over said test surface to create a measurement of a lubricant depletion to estimate said lubricant depletion of said slider over said disk surface in said disk drive.

12. The method of claim 11, further comprising the step of:
operating said atomic force microscope with said cantilevered probe over said test surface and stimulating a vertical micro-actuator to create a measurement of a scratch test to estimate said scratch test of said slider on said disk surface in said disk drive.

13. The method of claim 11, further comprising the steps of:
operating a Peltier plate thermally coupled to a test object including said test surface to maintain said test surface at a controlled test temperature.

14. The method of claim 11, further comprising the steps of:
supplying an atmospheric chamber with air at a test humidity, said atmospheric chamber enclosing said test surface and said slider.

15. A method, comprising the step of:
operating an atomic force microscope with a cantilevered probe containing a slider of a kind useable in a disk drive, said slider positioned over a test surface to create a measurement of a lubricant depletion to estimate said lubricant depletion of said slider over a disk surface in said disk drive, wherein said test surface is similar to said disk surface.

16. A method, comprising the step of:
operating said atomic force microscope with said cantilevered probe containing a slider of a kind useable in a disk drive and stimulating a vertical micro-actuator to create a measurement of a scratch test to estimate said scratch test of said slider on a disk surface in said disk drive, wherein said test surface is similar to said disk surface.

17. A method, comprising the step of: operating a Peltier plate thermally coupled to a test object including a test surface to create a test surface at a controlled test temperature in an atomic force microscope.

18. The method of claim 17, further comprising the step of:
supplying an atmospheric chamber with air at a controlled test humidity, said atmospheric chamber enclosing said test surface and said slider.

19. A cantilevered probe, comprising a cantilever coupled to a slider of a kind useable in a disk drive, and said cantilever configured for use in an atomic force microscope.

20. The cantilevered probe of claim 19, wherein said disk drive is a ferroelectric disk drive.

21. The cantilevered probe of claim 19, wherein said disk drive is a ferromagnetic disk drive.

22. The cantilevered probe of claim 19, further comprising a vertical micro-actuator coupled to said slider.
